(19) United States
(12) Patent Application Publication
(10) Pub. No.: US 2011/0203146 A1
(43) Pub. Date: Aug. 25, 2011

(54) GRAPHICAL DISPLAYS WITH OBJECT HOLDERS

(76) Inventor: Kevin L. Newcomer, Monroe, MI (US)

(21) Appl. No.: 13/035,076

(22) Filed: Feb. 25, 2011

Related U.S. Application Data
(60) Provisional application No. 61/307,889, filed on Feb. 25, 2010.

(51) Int. Cl. G09F 1/08; F16B 2/02; F16M 13/02; F16B 45/00

(52) U.S. Cl. 40/538; 248/316.1; 248/205.1; 248/305

(57) ABSTRACT

Systems, kits and methods allow a life-sized figure, whether configured as a cut-out or wall-mounted image, to be portrayed as “holding” a real musical instrument such as a guitar or a piece of sports equipment such as a tennis racket, thereby enhancing the visual appeal of the arrangement through the inclusion of a real, 3-D object while a storage function for the instrument or other implement when not in use. The invention may be configured for converting an existing wall-mounted figure or cut-out, or may be provided in kit form for later assembly. Apparatus and methods are also disclosed for taking photographs for life-sized novelty figures for use on cut-outs and wall-mounted displays, particularly when “action” shots are required.

### REFERENCE TO RELATED APPLICATION

This application claims priority from U.S. Provisional. Patent Application Ser. No. 61/307,889, filed Feb. 25, 2010, the entire content of which is incorporated herein by reference.

### FIELD OF THE INVENTION

This invention relates generally to decorative articles and, in particular, to stand-up, life-sized and wall-sized graphical displays including holders for musical instruments, sports equipment and other objects.

### BACKGROUND OF THE INVENTION

Life-sized novelty figures have become quite popular. There are basically two styles: free-standing cardboard cut-outs and wall-clinging decals (i.e., “Fatheads”). These novelty figures represent a wide range of personalities, ranging from cartoon characters to movie stars. Some of the figures, such as sports heroes and famous musicians, are depicted with sports-related implements or instruments like guitars. However, the implements or instruments are simply part of a flat picture. As such, while these life-sized graphical images are compelling in terms of size they are lacking in true three-dimensionality and functionality.

### SUMMARY OF THE INVENTION

This invention improves upon and extends the concept of large graphical displays through the inclusion of an object holder. This allows a life-sized figure, for example, whether configured as a cut-out or wall-mounted image, to be portrayed as “holding” a real musical instrument such as a guitar or a piece of sports equipment such as a tennis racket. Not only does this approach enhance the visual appeal of the arrangement through the inclusion of a real, 3-D object, the resulting display also provides a storage function for the instrument or other implement when not in use.

The invention may be configured for converting an existing wall-mounted figure or cut-out, or may be provided in kit form for later assembly. A system for making an existing graphical image of a person appear to be holding a real object comprises a support having a first portion that attaches to, or through, the graphical image, and a second portion configured to hold, support or grasp an object. The first portion of the support may be configured for attachment to a wall behind the image, with the second portion being configured to hold, support or grasp a musical instrument, sports-related implement, or other object. A plurality of supports may be provided to hold different portions of the object or different objects.

A kit to configure a decorative display in accordance with the invention comprises a novelty figure and a support having a first portion that attaches to or through the novelty figure and a second portion configured to hold, support or grasp an object. The novelty figure may be a stand-up cut-out, or may attach to or cling to a wall surface. The novelty figure may depict a well-known or famous individual such as a musician, athlete, sports hero or athlete. The invention further includes apparatus and methods for making life-sized photographs of novelty figures for use on cut-outs and wall-mounted displays, particularly when “action” shots are required.

### BRIEF DESCRIPTION OF THE DRAWINGS

FIG. 1 is a schematic drawing that shows a cutout positioned in front of a wall surface;

FIG. 2 shows a completed kit including a stand-up figure and a guitar holder;

FIG. 3 is a drawing that shows how a cut-out may be stabilized if positioned away from a wall surface;

FIG. 4 shows a novelty figure with a holder for the neck of a guitar;

FIG. 5 shows a novelty figure with a guitar stand;

FIG. 6 shows a novelty figure with a neck or shoulder strap;

FIG. 7 illustrates a cut-out figure with a holder for a tennis racket and ball;

FIG. 8 shows a cutout of a snowboarder with a board holder;

FIG. 9 depicts apparatus and methods for making life-sized novelty figures for use on cut-outs and wall-mounted displays, particularly when “action” shots are required;

FIG. 10A is a top-down view of a person to be photographed to create the image of FIG. 9;

FIG. 10B is a side view of the person of FIG. 10A;

FIG. 10C is a foot shot of the person of FIG. 10A; and

FIG. 10D is a head shot of the person of FIG. 10A.

### DETAILED DESCRIPTION OF THE INVENTION

This invention combines larger, graphical displays with a device for holding an object, thereby allowing a life-sized novelty figure, for example to appear to be holding or carrying a real sports-related implement, musical instrument, or other implement. The display may also be design with a custom-printed image of oneself, family member, friend, the family pet, a political favorite or other possible images.

Depending upon the embodiment, the graphical image may be wall-sized and/or wall-mounted or a free-standing picture or cut-out. If the image is mounted on or adhered to a wall surface, the object holder may be mounted immediately over the image. If the image forms part of a free-standing cut-out or display, the object holder may be mounted on the display or extend through the display to a wall surface for additional support. More than one object holder may be used in conjunction with a single graphical image, and a given object holder may include separate component parts. The final configuration depends upon the size and positioning of the image or display, the shape or weight of the object, or other considerations.

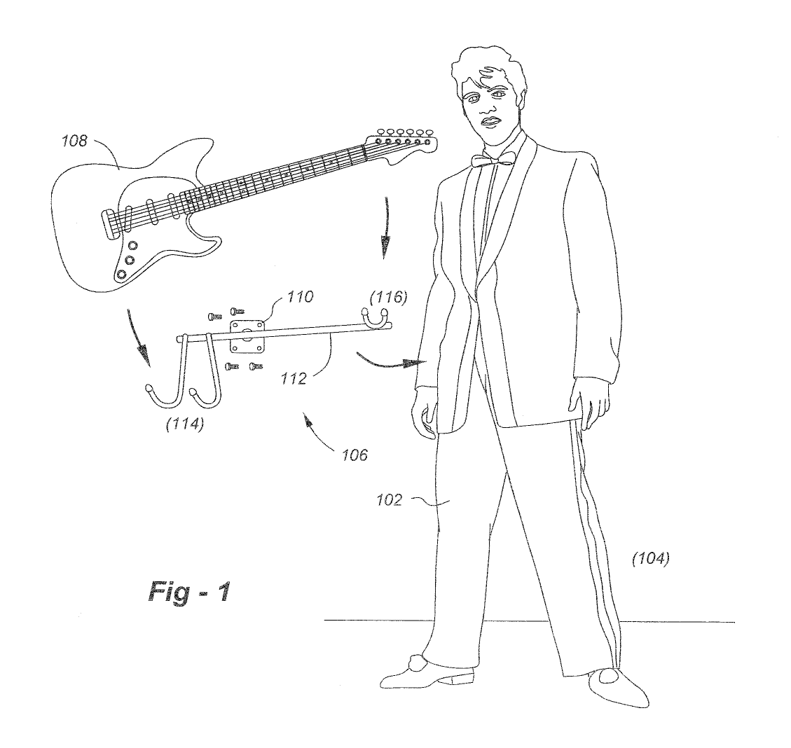

FIG. 1 is a schematic drawing that shows a cut-out 102, in this case including a life-sized figure. The cut-out may be made of flat stock or formed material, such as cardboard, foam core, or plastic, including thereto-formed plastics, with the image printed, bonded or adhered to the support backing material. “Cut-out” should be taken to include any shape including those conforming to the content of a picture as well as rectangular and other geometric shapes.

In addition to personalities, the cut-out may include replicas of objects, animals or places and may be mounted to a wall, or made to stand freely with the aid of a base. Freestanding cut-outs may be provided with a weighted base, such as a water- or sand-filled tank. Alternatively the cut-out may be attachable to a floor with fasteners, thereby eliminating the need for weighting. Non-freestanding cut-outs may include a pressure sensitive adhesive applied to the back to keep the cut-out flat against a wall surface.

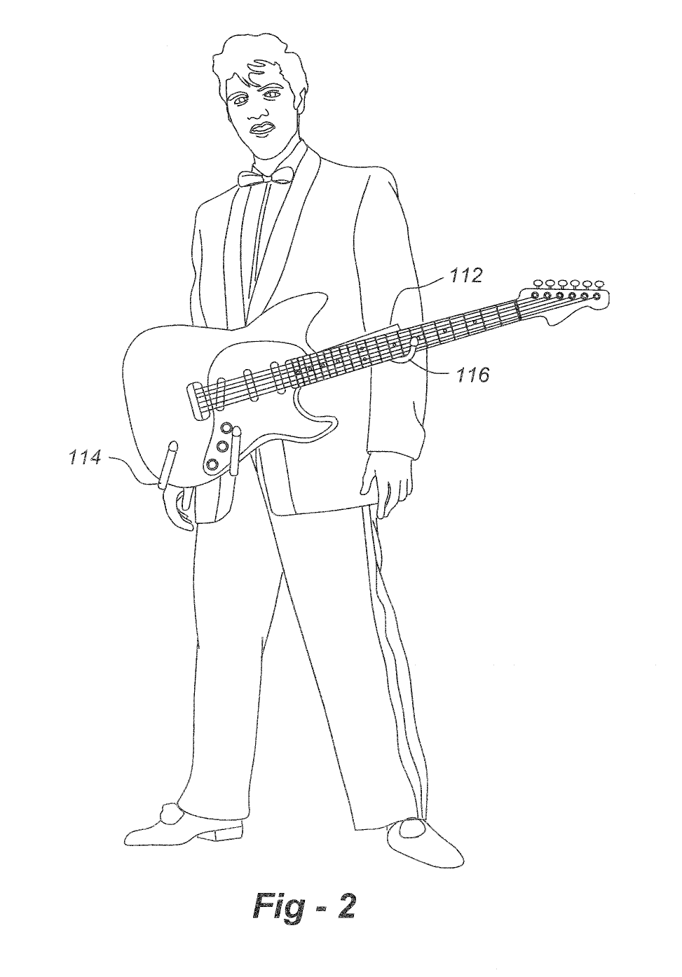

In FIG. 1 the cut-out 102 is positioned in front of a wall surface 104. The invention provides a kit with a holder 106 that mounts on or through the cutout 102, such that the novelty figure appears to be holding or carrying a guitar 108. The holder 106 includes a mounting plate 110 configured to receive a plurality of screws to secure the plate to the wall 104. In this embodiment, the plate 110 is coupled to a bar 112 having one end with hooks 114 to receive the body of guitar 108 and another end 116 to receive the neck of the guitar. FIG. 2 shows the completed kit with the novelty figure “holding” the guitar. If the image is positioned away form the wall surface extension hardware may be used as appropriate, as shown in FIG. 1

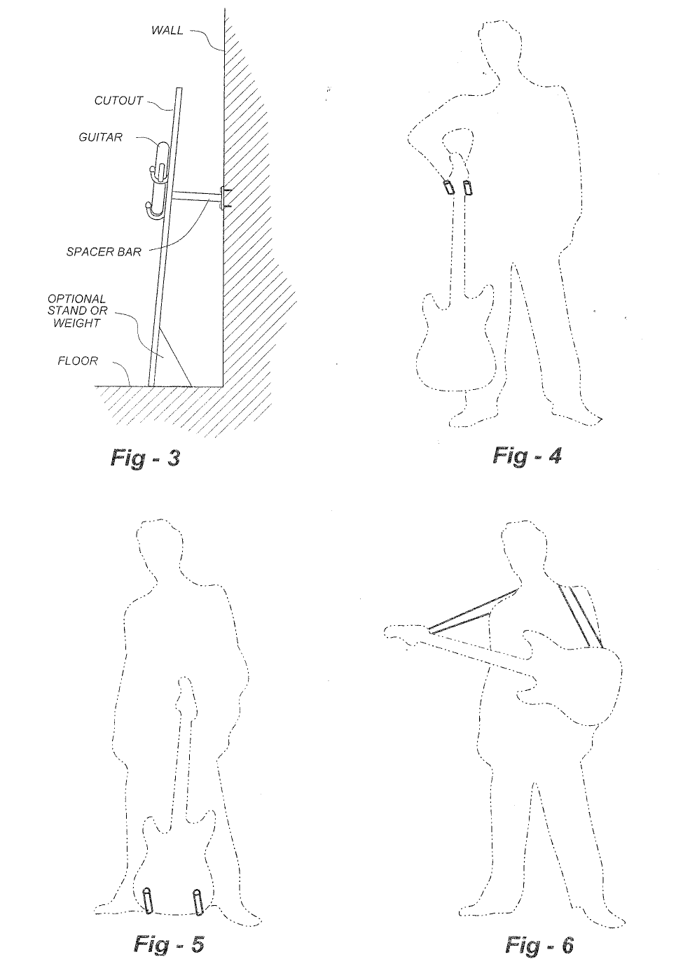

Numerous implementations are made possible by the invention. The mounting hardware may be mounted in front of, or behind, the cutout or display. The bar 112 may be rigidly coupled to a plate or it may swivel. Indeed, in the case of guitars, the holder may be any style, including. a neck-only holder (FIG. 4) or a body-only stand (FIG. 5). Particularly if cutout is free-standing, the kit may include a neck or shoulder strap (FIG. 6). Other types of holders may be provided for other musical instruments such as saxophones, violins, cellos, flutes, etc.

Object holders according to the invention may be in the form of stands or brackets, and may be fabricated using a variety of methods, using metal, plastic, composites, rubber or wood. If hooks are provided, the angle of the hooks may be adjustable to accommodate all types, sizes and configuration of guitars or other objects. U.S. Design Patent Application Ser. No. 29/385,811, the entire content of which is incorporated herein by reference, shows a different guitar holder applicable to the invention,

Display kits according to the invention can be used for holding all types of sports equipment, including golf clubs, hockey sticks, footballs, basketball, fishing poles, etc. A stand may be supplied with a cut-out of a famous athlete, sports image or custom-printed cutout of oneself or another participating in a sports-related activity. A custom-printed display may have an individual's face superimposed onto uniformed body of a favorite team member.

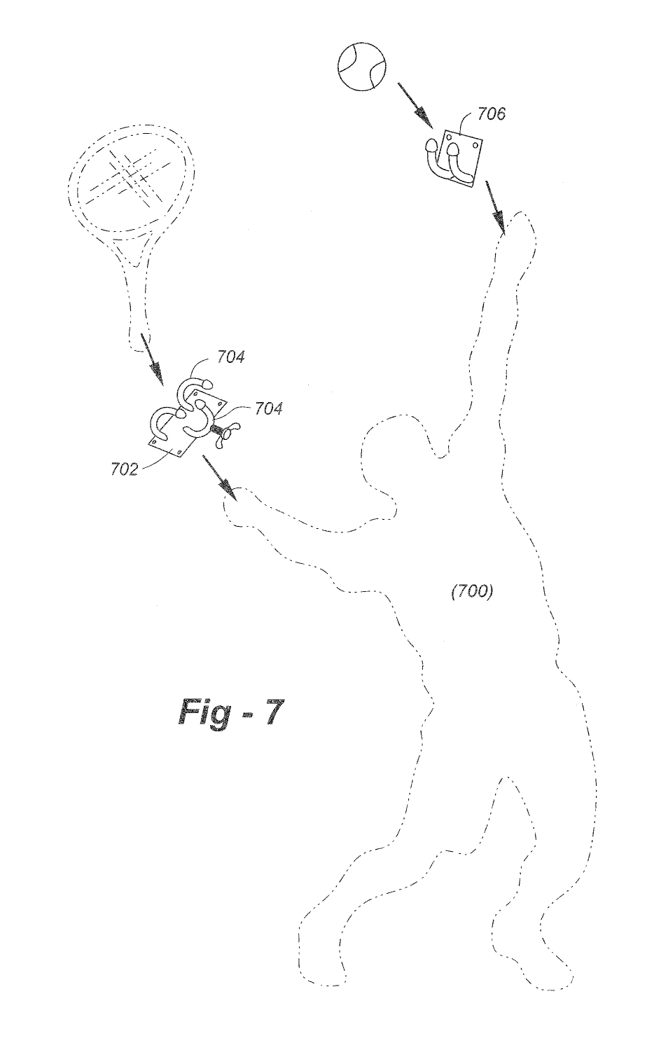

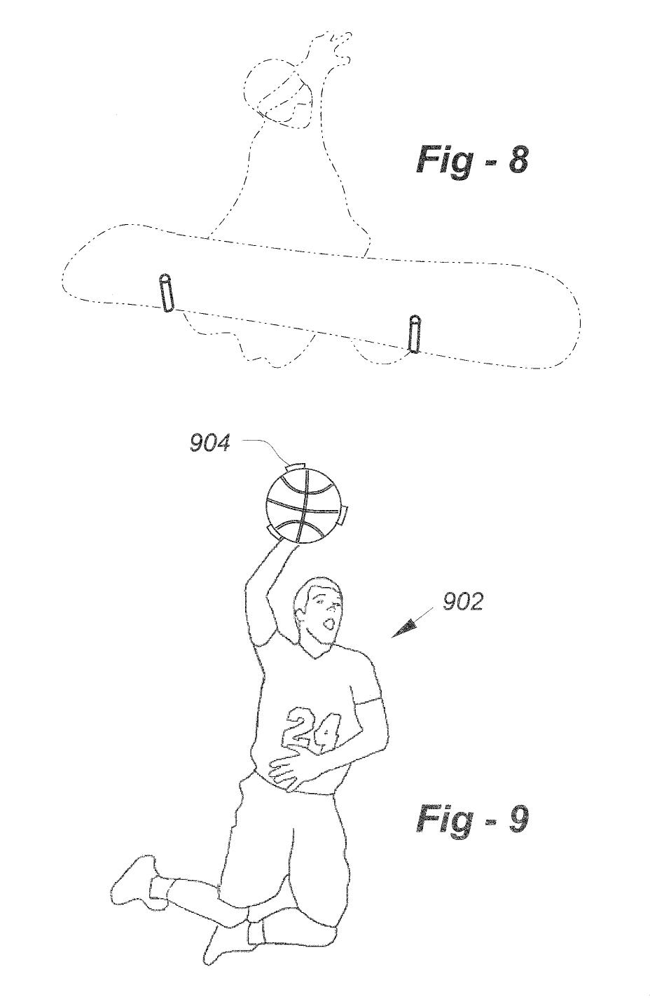

FIG. 7 shows a graphical image 700 with a plurality of holders for an implement with a handle such as a tennis racket, and a ball. The racket holder may include a plate 702 with adjustable jaws 704 to grip the handle. A separate ball holder 706 may include a pair of hooks or adjustable prongs. FIG. 8 shows a cutout of a snowboarder with a board holder. The invention may also provide graphical images and holders for household, residential or commercial items. For example, a maid or janitor character may be depicted holding a broom, mop or dust pail. A “chef” may hold cookbooks, pots and pans. A handy may or worker may be shown with tools in his/her hands or wearing a real tool belt.

The invention further includes apparatus and methods for making life-sized photographs of novelty figures for use on cut-outs and wall-mounted displays, particularly when “action” shots are required. FIG. 9 shows a photographic image 902 of a person ready to dunk a basketball. The image, which may form a part of a larger picture and which may be a cut-out, free-standing or wall-mounted, includes a three-pronged basketball holder 904. Such a photograph is difficult to capture by actually jumping into the air and using trial-and-error to get a good shot. The invention streamlines this process by providing various props and instructions to take pictures which simulate action.

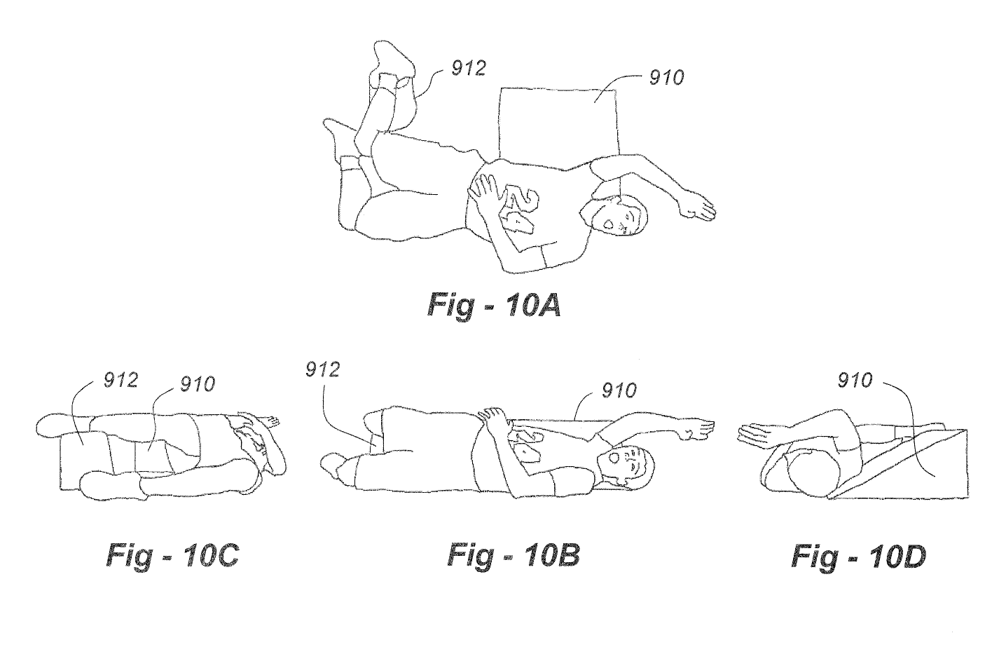

FIG. 10A is a top-down view of a person to be photographed to create the image of FIG. 9. The person is instructed to lie on the floor with their back against a first prop 910 and their right foot on a second support 912. FIG. 10B is a side view, FIG. 10C is a foot shot, and FIG. 10D is a head shot. The individual is further instructed to point their toes downwardly and their eyes upwardly, at which point the photo is taken.

I claim:

1. A system for making a graphical image of a person appear to be holding a real object, comprising:
a support having a first portion that attaches to, or through, the graphical image; and
wherein the support further includes a second portion configured to hold, support or grasp an object.

2. The system of claim 1, wherein the first portion of the support is configured for attachment to a wall behind the image.

3. The system of claim 1, wherein the second portion of the support is configured for holding a guitar.

4. The system of claim 1, wherein the second portion of the support includes one or more hooks to support the body of a guitar.

5. The system of claim 1, wherein the second portion of the support includes at least one hook to support the neck of the guitar.

6. The system of claim 1, wherein the second portion of the support includes one or more hooks to support the body of a guitar and at least one hook to support the neck of the Guitar.

7. The system of claim 1, wherein the second portion of the support includes a device to hold, support or grasp a sports-related implement.

8. The system of claim 1, wherein the second portion of the support includes a device to grasp the handle of a racket.

9. The system of claim 1, including a plurality of supports to hold different portions of the object or different objects.

10. A kit to configure a decorative display, comprising:
a novelty figure;
a support having a first portion that attaches to or through the novelty figure and a second portion configured to hold, support or grasp an object.

11. The kit of claim 10, wherein the novelty figure is a stand-up cut-out.

12. The kit of claim 1.0, wherein the novelty figure clings to a wall.

13. The kit of claim 10, wherein the novelty figure depicts a well-known or famous individual.

14. The kit of claim 10, wherein:
the novelty figure depicts a musician; and
the support is configured to hold a musical instrument.

15. The kit of claim 10, wherein:
the novelty figure depicts an athlete; and
the support is configured to hold a sports-related implement.

16. The kit of claim 10, wherein the novelty figure depicts a movie actor.
